(19) United States
(12) Patent Application Publication
(10) Pub. No.: US 2011/0303068 A1
(43) Pub. Date: Dec. 15, 2011

(54) Compression Punch System

(76) Inventors: Ross Exley, Clifton, NJ (US); Mark Shainwald, Clifton, NJ (US); Josh Piezas, Cranford, NJ (US)

(21) Appl. No.: 13/112,668

(22) Filed: May 20, 2011

Related U.S. Application Data
(60) Provisional application No. 61/353,525, filed on Jun. 10, 2010.

(51) Int. Cl. B26D 7/26

(52) U.S. Cl. 83/698.21

(57) ABSTRACT

A compression punching system comprises a base, a punch body, a punch tool, and an actuator. The base comprises a base die and a first polarized magnetic surface. The punch body is configured to engage the base. The punch body defines a punch cavity and comprises a second magnetically polarized magnetic surface. The second magnetically polarized surface is configured to magnetically engage the first polarized magnetic surface and position the punch body in corresponding alignment with the base. The punch tool is disposed in the punch cavity. The actuator slidably couples to the punch body. The actuator is movable relative to the punch body between a first resting position and a punching position, and the movement of the actuator causes movement of the punch body.

### CROSS-REFERENCE TO RELATED APPLICATIONS

This application claims priority to U.S. Provisional Patent Application Ser. No. 61/353,525 filed Jun. 10, 2010.

### TECHNICAL FIELD

The invention relates to a compression punching system for sheet media, such as a piece of paper, and more particularly to a punch that may be disposed at a variety of locations on the sheet media to form an image in the sheet media.

### BACKGROUND OF THE INVENTION

When working on decorative projects, such as for crafts, scrapbooking, invitations, or the like, a punch may be utilized to form a pattern on sheet media, such as, for example, paper, paperboard, and cardboard, by removing material from the sheet media so that either the material removed from the sheet media may be used for a decorative element, or the remaining sheet media with material removed may be used for a decorative element. Sometimes it is desired to create multiple different patterns or shapes on the sheet media, without having to obtain a separate punch. Thus, a need exists for a layering punch that allows a user to select from a plurality of patterns when forming a pattern on sheet media with a punch.

The present invention is provided to solve the problems discussed above and other problems, and to provide advantages and aspects not provided by prior punches. A full discussion of the features and advantages of the present invention is deferred to the following detailed description, which proceeds with reference to the accompanying drawings.

### SUMMARY OF THE INVENTION

According to one embodiment, a compression punching system for perforating or scoring sheet media is provided. The compression punching system comprises a base, a punch body, a punch tool, and an actuator. The base has an outer perimeter. The base comprises a base die and a first polarized magnetic surface. The punch body is configured to engage the base. The punch body defines a punch cavity and comprises a second magnetically polarized magnetic surface. The second magnetically polarized surface is configured to magnetically engage the first polarized magnetic surface and position the punch body in corresponding alignment with the base. The punch tool has a terminal edge, at least a portion of which defines a punch image. The punch tool is disposed in the punch cavity. The actuator slidably couples to the punch body. The actuator is movable relative to the punch body between a first resting position and a punching position. When the actuator is in the first resting position, the punch tool is retracted into the punch cavity such that the terminal edge of the punch tool defining the punch image does not extend beyond a bottom extent of the punch cavity. When the actuator is moved to the punching position, the terminal edge of the punch tool defining the punch image is moved to a position beyond a bottom extent of the punch cavity.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a compression punching system according to one embodiment.

FIG. 2 is a is a perspective view of the compression punching system of FIG. 1 with a punch body and a base in a separated arrangement.

FIG. 3 is a perspective view of the compression punching system of FIG. 1 with the punch body and the base in a separated arrangement with an actuator in a punching position.

FIG. 4 is a perspective view of the base of the compression punching system of FIG. 1.

FIG. 5 is a perspective view of the actuator and the punch body of the punching system of FIG. 1.

FIG. 6 is a perspective view of the compression punching system of FIG. 1 with the actuator removed. And,

FIG. 7 is a perspective view of the punch body and the punch mechanism of the compression punching system of FIG. 1.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

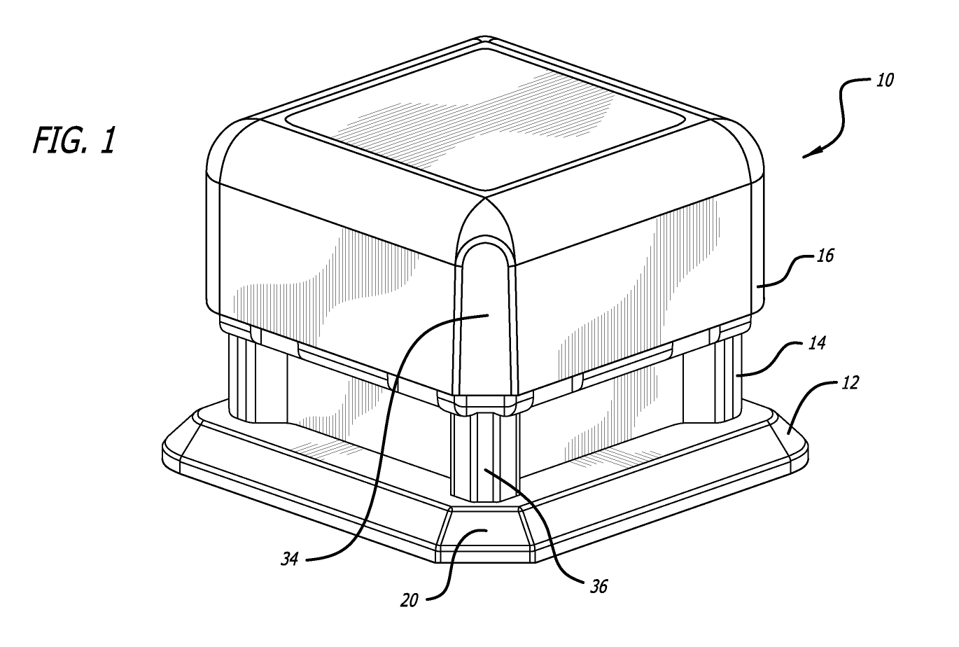

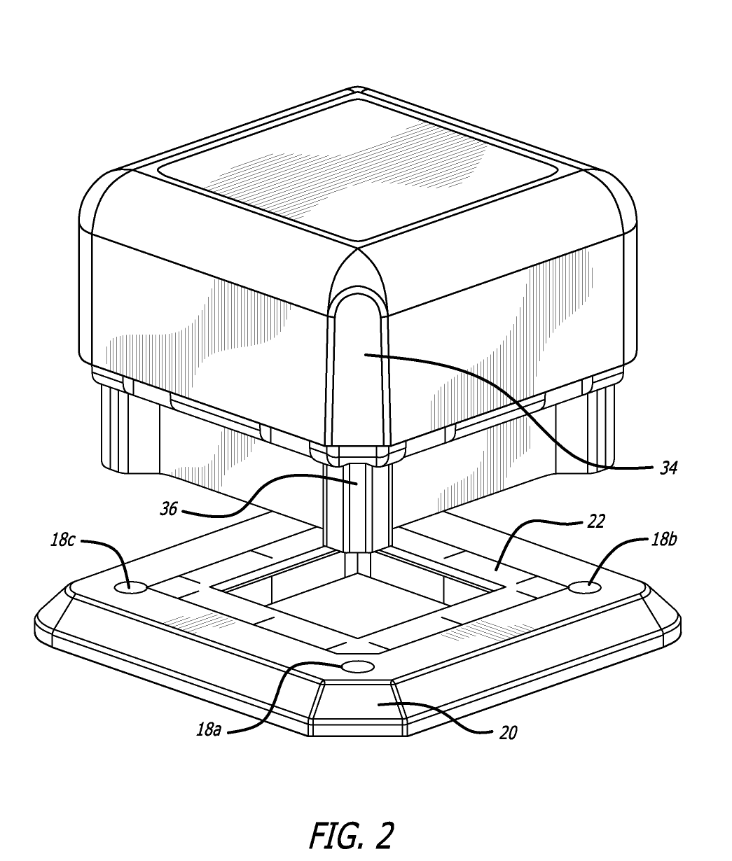

FIGS. 1-3 show a compression punching system 10 that comprises a base 12, a punch body 14, and an actuator 16. The base 12 has an outer perimeter and contains a plurality of magnets 18a-18d. The plurality of magnets 18a-18d generate a polarized magnetic surface on the base 12. The polarity of at least one of the magnets 18a-18d differs from the polarity of the remaining magnets. For instance, a first magnet 18a may have a first polarity, while the remaining magnets 18b-18d may have a second polarity.

The base 12 has a base die 22. The base die 22 is removably connected to the remainder of the base 12. The base die 22 has an opening 23 formed therein to receive a punch tool 38 described below.

The base 12 additionally has an aligning feature 20. As shown in FIGS. 1-3, the aligning feature 20 is a flat provided on a corner of the base 12. It is also contemplated that the aligning feature may be provided in other manners, such as an image printed on the base 12, a negative relief image on the base 12, text on the base 12, or other indicia provided on the base 12.

In order to align the punch body 14 and the actuator 16 with the base 12, the actuator 16 may be provided with an aligning feature 34 and the punch body 14 may have an aligning feature 36. As the punch body 14 and the actuator 16 are typically attached, it is contemplated in some embodiments that only one of the actuator 16 and the punch body 14 have an aligning feature 34, 36. The aligning features 34, 36 respectively disposed on the actuator 16 and the punch body 14 provide a user with a visual indication that the base 12 is properly aligned with the punch body 14 and the actuator 16. The aligning features 34, 36 may take on a variety of forms including, but not limited to, a positive relief image to engage a negative relief image on the base 12.

As shown in FIG. 5, the punch body 14 has a plurality of magnets 30a-30d. The plurality of magnets 30a-30d generate a polarized magnetic surface on the punch body 14. The polarity of at least one of the magnets 30a-30d differs from the polarity of the remaining magnets. For instance, a first magnet 30a may have a first polarity, while the remaining magnets 30b-30d may have a second polarity. The polarity of the magnets 30a-30d are generally opposite the corresponding magnet 18a-18d in the base 12, so that the magnets 18a-18d in the base 12 are attracted to the magnets 30a-30d in the punch body 14 when the base 12 and the punch body are properly aligned, but the punch body 14 will be repelled from the base 12 when the magnet 18a-18d, 30a-30d are not properly aligned. Thus, the base 12 and the punch body 14 may only be utilized in a proper orientation, otherwise the magnets 18a-18d, 30a-30d repel each other.

It is contemplated that the magnets 30a-30d of the punch body 14 may be provided in a separate component, such as a detachable alignment ring.

Also shown in FIG. 5 is a punch cavity 32 formed in the punch body 14. The cavity 32 is adapted to receive a punch tool 38. The punch tool 38 is removably mounted within the punch cavity 32 of the punch body 14, such that the punch tool 38 may be replaced by a different punch tool with a different design. The punch tool 38 may be secured in the punch cavity 32 by a press fit, or by mechanical fasteners, such as tabs and slots, or other manners known in the art. The punch tool 38 has a terminal edge 40 that defines a punch image that is formed in sheet media.

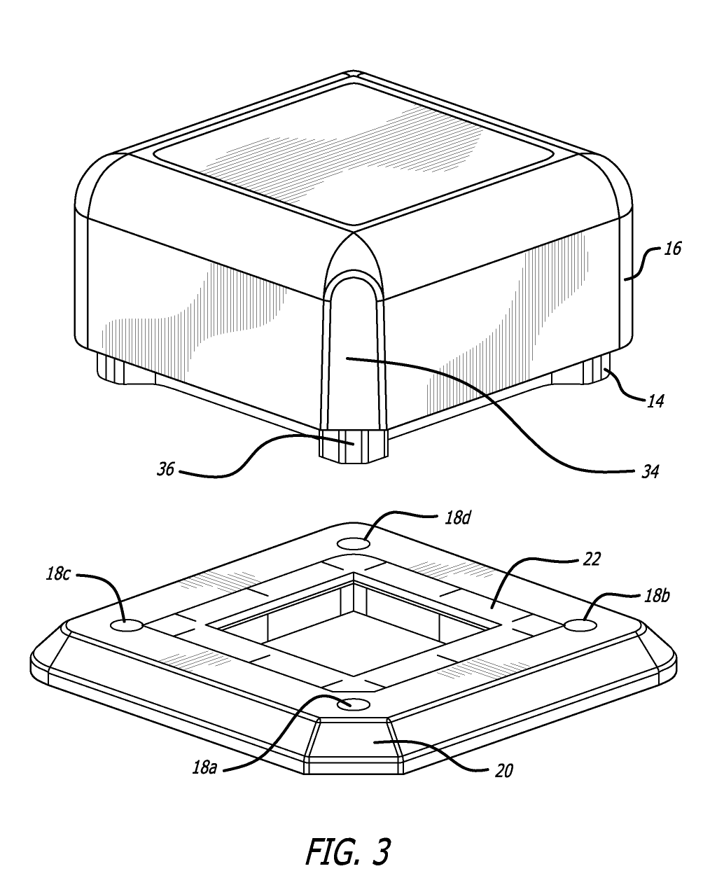

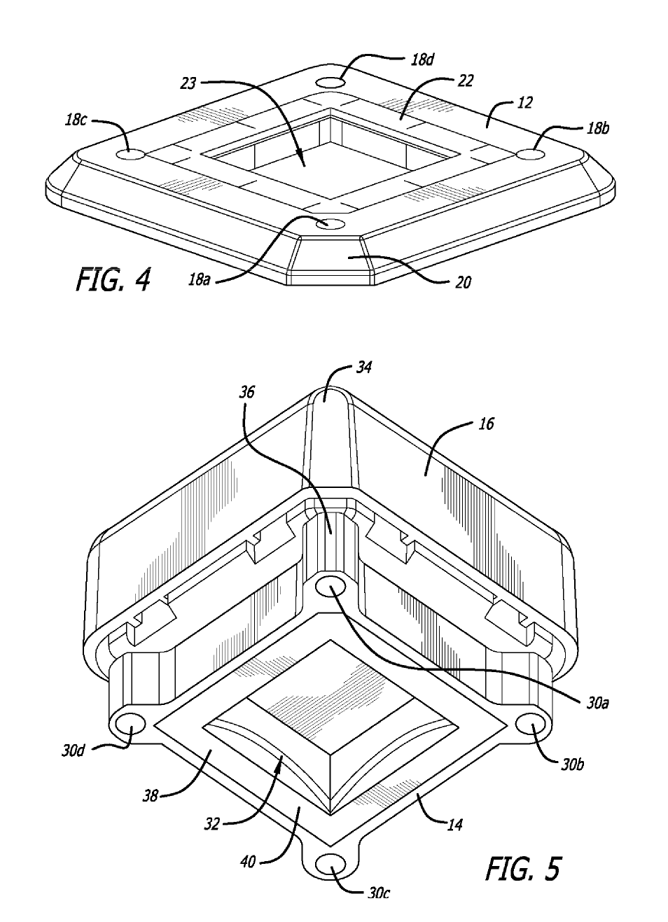

The compression punching system 10 further has an actuator 16. The actuator 16 is slidably coupled to the punch body 14. The actuator 16 is movable relative to the punch body 14 from a first position, as shown in FIG. 1, to a second position, as shown in FIG. 3. The first position of the actuator may be a resting position, and the second position may be a punching position. When the actuator 16 is disposed in the first position, the punch tool 38 retracts into the punch cavity 32 of the punch body 14. When the actuator 16 is disposed in the second position, the punch tool 38 extends beyond the punch cavity 32, such that the punch tool 38 may engage the sheet media. The movement of the punch tool 38 beyond the punch cavity 32 allows the punch tool to engage the base die 22 and form an image in the sheet media.

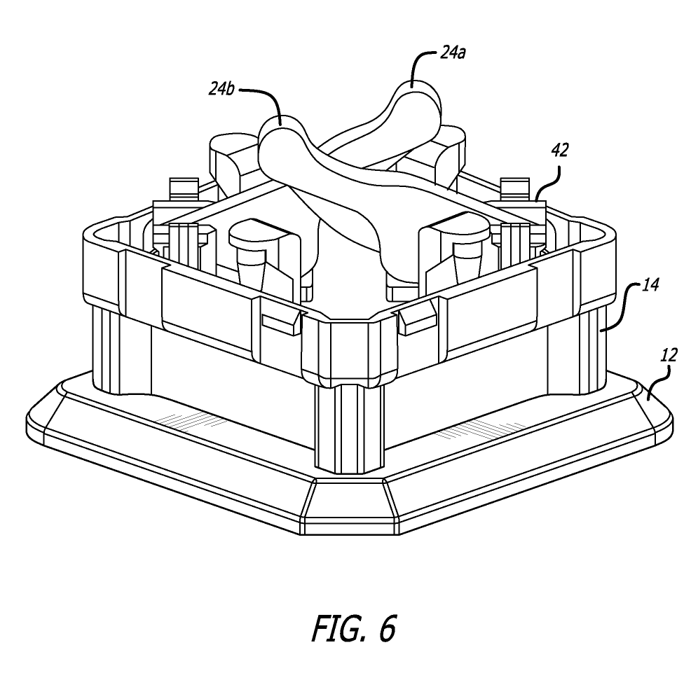

FIG. 6 depicts the compression punching system 10 with the actuator 16 removed. As shown in FIG. 6, a first actuator arm 24a and a second actuator arm 24b are pivotally connected to a punch body support frame 42. The actuator arms 24a, 24b pivot as the actuator 16 is depressed from the first position to the second position.

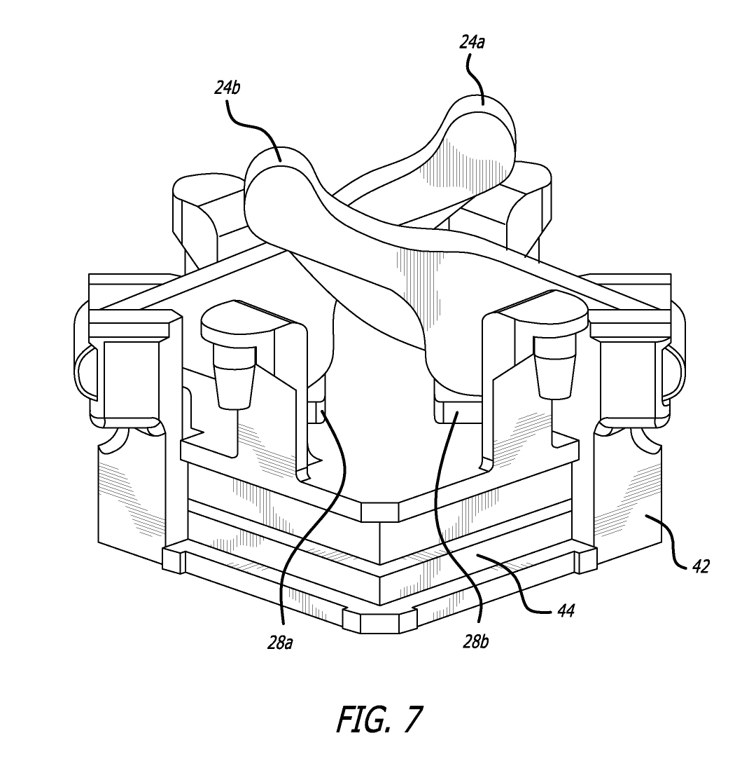

FIG. 7 shows the punch body 14 with a punch body housing removed as well as the actuator arms 24a, 24b. The first actuator arm contacts a first contact pad 28a on a movable portion 44 of the punch body 14. The movable portion 44 of the punch body 14 is adapted to move vertically in order to allow the punch tool 38 to be utilized on the sheet media. The movement of the moveable portion 44 of the punch body 14 also moves the punch tool 38. As the actuator 16 moves from the first position to the second position, the actuator arms 24a, 24b rotate and act as a cam against the contact pads 28a, 28b to displace the moveable portion 44 of the punch body 14 downward, thereby causing the punch tool 38 to extend beyond the punch cavity 32. It is contemplated that biasing device, such as springs, may bias the moveable portion 44 of the punch body 14 to a non-punching position, such that when force is not applied to the actuator 16, the actuator 16 and the actuator arms 24a, 24b are positioned in the first position. The use of multiple actuator arms 24a, 24b applies more even force to the moveable portion 44 of the punch body 14 to allow for more uniform punching of the sheet media.

While the specific embodiments have been illustrated and described, numerous modifications come to mind without significantly departing from the spirit of the invention, and the scope of protection is only limited by the scope of the accompanying Claims.

What is claimed is:

1. A compression punching system for perforating or scoring sheet media, the compression punching system comprising:
a base having an outer perimeter, the base comprising a base die and a first polarized magnetic surface; and
a punch body configured to engage the base, the punch body defining a punch cavity and comprising a second magnetically polarized magnetic surface, the second magnetically polarized surface being configured to magnetically engage the first polarized magnetic surface and position the punch body in corresponding alignment with the base;
a punch tool having terminal edge, at least a portion of which defines a punch image, the punch tool being disposed in the punch cavity; and,
an actuator slidably coupled to the punch body, the actuator being movable relative to the punch body between a first resting position and a punching position, wherein when the actuator is in the first resting position, the punch tool is retracted into the punch cavity such that the terminal edge of the punch tool defining the punch image does not extend beyond a bottom extent of the punch cavity, and wherein when the actuator is moved to the punching position, the terminal edge of the punch tool defining the punch image is moved to a position beyond a bottom extent of the punch cavity.

2. The compression punching system of claim 1 further comprising at least one aperture in the base die.

3. The compression punching system of claim 2 wherein the at least one aperture is configured to define a complimentary die image to the punch image, wherein when the actuator is moved to the punching position, at least a portion of the terminal end of the punch tool passes through the aperture.

4. The compression punching system of claim 1 further comprising an alignment image disposed on the base die.

5. The compression punching system of claim 1 wherein the contact surface of the base die defines a negative relief image and wherein the punch body further includes a punch body contact surface, the punch body contact surface comprising a positive relief image configured to engage the negative relief image in the base die.

6. The compression punching system of claim 1, wherein the first and second polarized magnetic surface are oriented such that magnetic engagement occurs only when the die and the punch body are disposed in complimentary alignment.

7. The compression punching system of claim 1, wherein at least one of the first and second polarized magnetic surface comprise a plurality of magnets.

8. The compression punching system of claim 1, wherein the actuator comprises a plurality of levers configured to work in opposing directions.

9. The compression punching system of claim 1, wherein the punch body comprises a detachable alignment ring, wherein the second magnetically polarized surface is disposed in the alignment ring.

10. The compression punching system of claim 1, wherein the base die is disposed within an inner punch perimeter of the base, and wherein the base includes an alignment surface disposed between the inner punch perimeter and the outer perimeter of the base.

11. The compression punching system of claim 10, wherein the alignment surface comprises a plurality of alignment indicia, wherein when a sheet media is aligned with a first of the plurality of alignment indicia, the punch tool is aligned to punch a first hole and wherein the sheet media is moved to a second of the plurality of alignment indicia, the punch tool is aligned to punch a second hole.

12. The compression punching system of claim 1, further comprising the base die having a first aligning feature and the actuator having a second aligning feature, wherein the aligning of the first aligning feature and the second aligning feature properly orients the first polarized magnetic surface and the second polarized magnetic surface.

13. The compression punching system of claim 1, further comprising the base die having a first aligning feature and the punch body having a second aligning feature, wherein the aligning of the first aligning feature and the second aligning feature properly orients the first polarized magnetic surface and the second polarized magnetic surface.

14. The compression punching system of claim 1, wherein the actuator is further removably coupled to the punch body.

15. The compression punching system of claim 14, wherein removal of the actuator from the punch body provides access to the punch cavity.
